(19) United States
(12) Patent Application Publication
(10) Pub. No.: US 2019/0274461 A1
(43) Pub. Date: Sep. 12, 2019

(54) Retrofit port for redirecting steam on vertically-vented pressure cookers

(71) Applicant: Joshua C. Nichols, Wichita Falls, TX (US)

(72) Inventor: Joshua C. Nichols, Wichita Falls, TX (US)

(21) Appl. No.: 15/932,489

(22) Filed: Mar. 7, 2018

(51) Int. Cl. A47J 27/09; A47J 36/38; A47J 36/02; F16L 43/00

(52) U.S. Cl. CPC A47J 27/09; F16L 43/00; A47J 36/02; A47J 36/38

(57) ABSTRACT

A method for redirecting steam on pressure cookers by means of a retrofit port is disclosed. The invention being comprised of a silicone port having an elbow-shape that is selectively affixed to existing cookers with vertically-oriented vents that allows steam to be redirected to a user's preference. Such pressure cookers include, but are not limited to; the popular DUO™ and Smart™ cooker models by Instantpot™. An object of the invention is to enhance the safety of existing, vertically vented pressure cookers.

### FIELD OF THE INVENTION

The present invention generally relates to pressure cookers. More specifically, it relates to a method and system for redirecting steam on vertically-venting pressure cookers by means of a retrofit port.

### BACKGROUND

Pressure cookers have a long history. The first pressure cooker was invented by French physicist Denis Papin in the late 1600s and he called it the ‘steam digester.’ His invention used internal steam pressure to increase the boiling point of water to cook foods faster. In the 1800s, Napoleon awarded 12,000 francs to an inventor who used a pressure cooker to preserve rations for the French army. By the 18th century, pressure cookers gained wide acceptance in canning and in the early 1900s, the USDA determined that pressure canning was the only safe method of preserving low-acid foods without risk of food poisoning. In the mid 1900s, Presto developed stove-top pressure cookers with interlocking covers and simple pressure relief valves. Such valves are a critical part of the apparatus as they allow the cooker to intermittently vent, preventing the buildup of pressure that can lead to potential explosions. Obviously the use of pressure cookers does not come without some risk. In recent times, negligent manufactures have placed consumers at risk with poor pressure cooker designs. For example, the Power Cooker XL by Tristar Products™ developed a lid that failed to lock when the pressure relief valve did not vent the pot properly leading to many lawsuits. Regardless of such setbacks, pressure cooker venting continues to improve and some in the industry have begun making more robust vents for manufacturers. U.S. Pat. No. 4,560,143A and European Patent No. 1295552A1 granted to Robinson and Capellan respectively, disclosed a relief valve assemblies for manufacturers that redirects venting steam away from a pot in various directions. While some improvements are being made, little was found in the prior art that included a vent redirect retrofit kit for vertical-venting pressure cookers.

### SUMMARY OF THE INVENTION

The device herein disclosed and described provides a solution to the shortcomings in the prior art through the disclosure of a method and system for redirecting steam from popular, existing, vertically-vented pressure cookers. An object of the invention is to enhance the safety of vertically-oriented steam vents. For example the popular DUO™ and Smart™ cooker models by Instantpot™ have pressure release valves that are based upon a swivel port with a swing tab. Users are required to manually turn this vent port tab to allow venting to take place. If a user clutches the port with their palm and turns the port they can be easily burned by saturated steam exiting at a high velocity form the cooker. Such exposure has been known to cause second degree burns to the skin. The aforementioned invention easily installs on such vent tabs and because it has an elbow shape redirects steam flow away from a user.

Another object of the invention is to provide a means to protect kitchen furnishing and appliances. For example the popular DUO™ and Smart™ cooker models by Instantpot™ have vertical, steam ventilation that can direct steam up underneath cabinets and ceilings. A majority of modern kitchen cabinets are constructed of wood laminate composites such as veneers, plastics wood fibers and various glues. When such furnishings are exposed to chronic moisture, particularly steam under pressure, they delaminate and become warped. In some extreme cases it can cause permanent damage and even cause the release of harmful volatile organic compounds from glues binding the wood fibers. In addition, exposing ceilings to chronic moisture also has the potential to trigger mold growth—further placing a user at risk over time.

It is briefly noted that upon a reading this disclosure, those skilled in the art will recognize various means for carrying out these intended features of the invention. As such it is to be understood that other methods, applications and systems adapted to the task may be configured to carry out these features and are therefore considered to be within the scope and intent of the present invention, and are anticipated. With respect to the above description, before explaining at least one preferred embodiment of the herein disclosed invention in detail, it is to be understood that the invention is not limited in its application to the details of construction and to the arrangement of the components in the following description or illustrated in the drawings. The invention herein described is capable of other embodiments and of being practiced and carried out in various ways which will be obvious to those skilled in the art. Also, it is to be understood that the phraseology and terminology employed herein are for the purpose of description and should not be regarded as limiting.

As such, those skilled in the art will appreciate that the conception upon which this disclosure is based may readily be utilized as a basis for designing of other structures, methods and systems for carrying out the several purposes of the present disclosed device. It is important, therefore, that the claims be regarded as including such equivalent construction and methodology insofar as they do not depart from the spirit and scope of the present invention. As used in the claims to describe the various inventive aspects and embodiments, “comprising” means including, but not limited to, whatever follows the word “comprising”. Thus, use of the term “comprising” indicates that the listed elements are required or mandatory, but that other elements are optional and may or may not be present. By “consisting of” is meant including, and limited to, whatever follows the phrase “consisting of”. Thus, the phrase “consisting of” indicates that the listed elements are required or mandatory, and that no other elements may be present. By “consisting essentially of” is meant including any elements listed after the phrase, and limited to other elements that do not interfere with or contribute to the activity or action specified in the disclosure for the listed elements. Thus, the phrase “consisting essentially of” indicates that the listed elements are required or mandatory, but that other elements are optional and may or may not be present depending upon whether or not they affect the activity or action of the listed elements.

The objects features, and advantages of the present invention, as well as the advantages thereof over existing prior art, which will become apparent from the description to follow, are accomplished by the improvements described in this specification and hereinafter described in the following detailed description which fully discloses the invention, but should not be considered as placing limitations thereon.

### BRIEF DESCRIPTION OF THE FIGURES

The accompanying drawings, which are incorporated herein and form a part of the specification, illustrate some, but not the only or exclusive, examples of embodiments and/or features.

FIG. 1 shows a perspective view of the invention installed on a pressure cooker.

FIG. 2 shows a section view of the invention affixed to an existing vertical vent.

Other aspects of the present invention shall be more readily understood when considered in conjunction with the accompanying drawings, and the following detailed description, neither of which should be considered limiting.

### DETAILED DESCRIPTION OF FIGURES

In this description, the directional prepositions of up, upwardly, down, downwardly, front, back, top, upper, bottom, lower, left, right and other such terms refer to the device as it is oriented and appears in the drawings and are used for convenience only; they are not intended to be limiting or to imply that the device has to be used or positioned in any particular orientation.

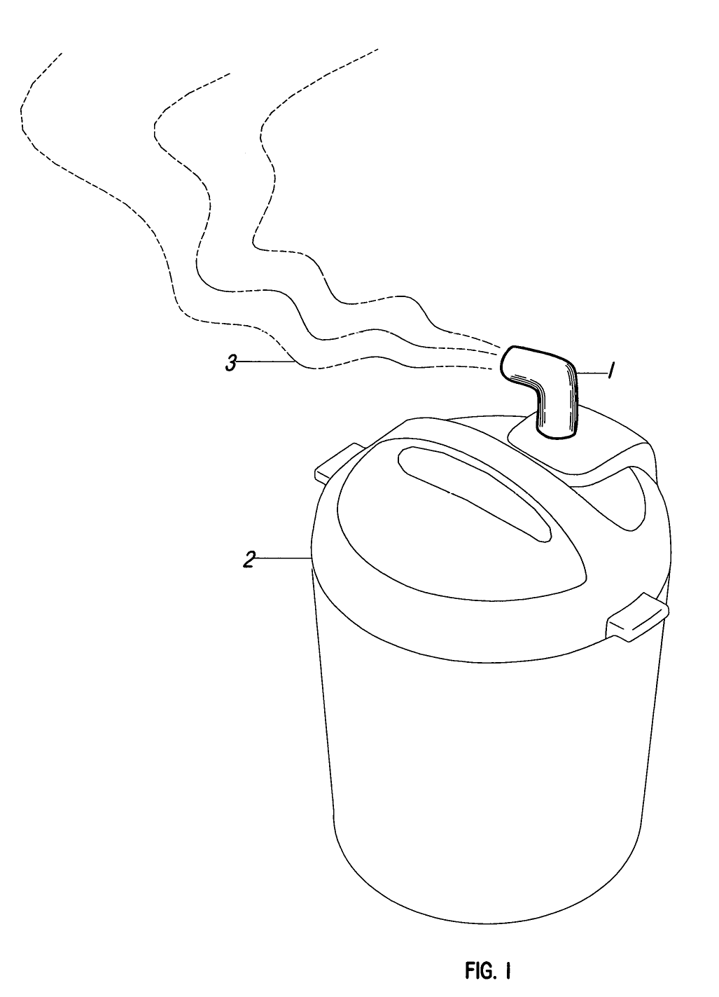

FIG. 1 shows a perspective view of the invention 1 installed on a pressure cooker 2 comprised of an elbow-shaped, hollow cylinder made of a rigid or flexible material, such as but not limited to FDA approved silicone or a metal etc. respectively. The image showing said invention having an open, distal end configured to receive vertical-oriented pressure vents such as, but not limited to: DUO™ and Smart™ cooker models by Instantpot™ and the like. The invention redirecting steam emanating from said vertically-oriented valve horizontally and away from said pressure cooker 2.

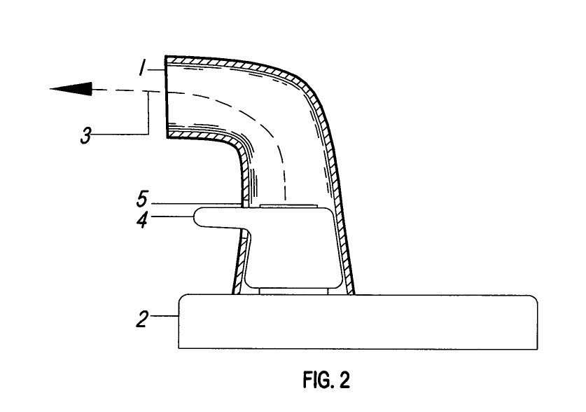

FIG. 2 shows a section view of the invention affixed to an existing vertical vent 4. The invention having another distal end with an opening disposed to receive said vertical vent 4 perpendicular to its longitudinal axis to prevent lateral movement thereon. The invention also having a proximal orifice 5 configured to receive lever tab 4 on said vertical vent therein. Said orifice 5 to prevent the invention from moving vertically when under load from steam pressure.

It is additionally noted and anticipated that although the device is shown in its most simple form, various components and aspects of the device may be differently shaped or slightly modified when forming the invention herein. As such those skilled in the art will appreciate the descriptions and depictions set forth in this disclosure or merely meant to portray examples of preferred modes within the overall scope and intent of the invention, and are not to be considered limiting in any manner. While all of the fundamental characteristics and features of the invention have been shown and described herein, with reference to particular embodiments thereof, a latitude of modification, various changes and substitutions are intended in the foregoing disclosure and it will be apparent that in some instances, some features of the invention may be employed without a corresponding use of other features without departing from the scope of the invention as set forth. It should also be understood that various substitutions, modifications, and variations may be made by those skilled in the art without departing from the spirit or scope of the invention.

What is claimed is:

1. A retrofit port for vertical-venting, pressure cookers comprised of a hollow, elbow-shaped, cylindrical device with open distal ends and proximal orifice.

2. The retrofit port of claim 1 enhancing the safety of vertically-oriented steam vents with horizontal steam flow redirection.

3. The retrofit port of claim 1 providing a means to protect kitchen furnishing and appliances with horizontal steam flow redirection.
